(19) United States
(12) Patent Application Publication
(10) Pub. No.: US 2013/0074947 A1
(43) Pub. Date: Mar. 28, 2013

(54) CONDENSATE LIFTING INSTALLATION SYSTEM

(71) Applicant: GRUNDFOS HOLDING A/S, Bjerringbro (DK)

(72) Inventors: Riccardo DAL CANTO, Livorno (IT); Alessandro IACOPONI, San Lorenzo a Pagnatico (Cascina) Pisa (IT); Thomas MEYER, Hamburg (DE); Ralf SCHOMÄCKER, Bielefeld (DE)

(73) Assignee: GRUNDFOS HOLDING A/S, Bjerringbro (DK)

(21) Appl. No.: 13/623,233

(22) Filed: Sep. 20, 2012

(30) Foreign Application Priority Data
Sep. 22, 2011 (EP) 11 182 382.9

(51) Int. Cl. F03B 11/00

(52) U.S. Cl. 137/312

(57) ABSTRACT

A condensate lifting installation system is provided having a lifting unit (2), which includes a collection container (6) and a pump assembly (9), and a neutralization unit (4), which includes a receiver space (20) for a neutralizing agent. The lifting unit (2) is designed at its upper side for the releasable attachment of the neutralization unit (4).

### BACKGROUND OF THE INVENTION

The invention relates to a condensate lifting installation system having a lifting unit and having a neutralization unit.

Condensate lifting installations are applied in order to pump or lift condensation, for example from heating installations, which occurs at a level below a waste water conduit, to the level of the waste water conduit. The condensate lifting installations as a rule comprise a lifting unit which has a collection container, into which the condensate to be delivered flows. A pump assembly is arranged in or on the collection container and pumps the condensate out of the collection container into a waste-water conduit which is situated higher. The pump assembly is switched on and off in dependence on the water level in the collection container. For this purpose, a suitable level switch, for example a float switch, is arranged in or on the collection container. Since the condensate of heating installations often has an acidic pH-value, it is necessary or stipulated in certain cases of application to neutralize the condensate. For this purpose, neutralization units are used, in which a suitable neutralizing agent, for example in the form of a granulate of lime, dolomite and/or magnesium oxide or the like, is arranged. The condensate is led through this neutralizing agent, before it flows into the lifting unit, which is to say its collection container. If such a neutralization unit is applied next to a lifting unit, this necessitates a more complicated assembly, since both units need to be connected to one another in a suitable manner.

### BRIEF SUMMARY OF THE INVENTION

With regard to this problem, it is an object of the present invention to provide a condensate lifting installation system which permits a simple and flexible combination of a lifting unit and a neutralization unit.

This object is achieved by a condensate lifting installation system having a lifting unit, which comprises a collection container and a pump assembly, as well as having a neutralization unit which comprises a receiver space for a neutralizing agent, wherein the lifting unit at its upper side is designed for the releasable attachment of the neutralization unit. Preferred embodiments are to be deduced from the subsequent description as well as the attached figures.

The condensate lifting installation system according to an embodiment of the invention comprises two components, on the one hand a lifting unit and on the other hand a neutralization unit, which may be arranged upstream of the lifting unit in the flow path of the condensate. The lifting unit is designed in a known manner having a collection container and having a pump assembly which is arranged on or in the collection container. The condensate to be delivered flows into the collection container and is pumped out of this container by the pump assembly into a connecting exit conduit which may lead into a higher situated waste water conduit. A level switch, for example in the form of a float switch, is arranged in a known manner on or in the collection container, for switching the pump assembly on and off.

The neutralization unit is provided in order to neutralize condensate having an acidic pH-value, before it flows into the collection container of the lifting unit, and this neutralization unit is arranged upstream of the lifting unit in the flow path departing from the condensate source to the waste water conduit. The neutralization unit has a receiver space for a neutralizing agent. This may be, for example, a granulate in the form described above, through which the condensate is led.

According to an embodiment of the invention, the lifting unit is designed such that the neutralization unit may be releasably attached on its upper side. This means that the neutralization unit may be placed directly onto the upper side of the lifting unit, whereby the effort with regard to installation is simplified, since the neutralization unit and lifting unit in this manner may be easily connected to one another and then be set up in operation at the place of application as a module. The releasable attachment of the neutralization unit on the lifting unit, however, has the advantage that this neutralization unit, on the one hand, may be removed for maintenance purposes with regard to the lifting unit and, on the other hand, may also be set up independently of the lifting unit, i.e. next to this. This may be desirable if the construction space does not permit an arrangement of the neutralization unit above the lifting unit. Moreover, it is also possible to apply the same lifting unit even without the neutralization unit, for example if the condensate is of a nature such that no neutralization is necessary. Thus, one and the same lifting unit may be used and provided with or without a neutralization unit. The variety of parts is reduced in this manner. The neutralization unit may, for example, be offered by the manufacturer as an additional accessory to the lifting unit.

The lifting unit on its upper side preferably has a shape which corresponds to the shape of the lower side of the neutralization unit, in a manner such that the upper side of the lifting unit and the lower side of the neutralization unit may come into releasable engagement with one another, in order to favor the attachment of the neutralization unit on the upper side of the lifting unit. Thus, for example, a plug connection may be created between the neutralization unit and the lifting unit, by which plug connection the neutralization unit is stuck onto the lifting unit from above and is fixed by the connection, in particular in the horizontal direction, so that it may not slip away from the upper side of the lifting unit. Additionally, a non-positive (force) fit and or positive (material) fit fixation, e.g. by screws, may be provided between the lifting unit and the neutralization unit.

The shape of the upper side of the lifting unit is thereby preferably defined by an outer housing part of the lifting unit. This outer housing part, in particular, is an upper housing part which covers the electrical components of the lifting unit, thus for example the electrical drive motor and switch devices respectively. It is preferable for this upper housing part to always remain on the lifting unit, independently of whether the neutralization unit is applied onto the lifting unit or not. Thus, it is not necessary to disassemble any housing parts of the lifting unit, before the neutralization unit is placed onto the lifting unit. Thereby, on the one hand, the assembly is simplified and, on the other hand, the outer housing part of the lifting unit retains its protective function of covering electrical components in the inside.

Moreover, it is preferable for the neutralization unit on its lower side to comprise at least one exit opening and for the lifting unit on its upper side to comprise at least one entry opening, which are arranged in a manner such that the exit opening lies opposite the entry opening when the neutralization unit is arranged on the upper side of the lifting unit. Thus, condensate from the exit opening of the neutralization unit may flow directly on account of gravitational force into the entry opening of the lifting unit. This moreover allows a very simple assembly, since one does not need to create complicated connections between the neutralization unit and the lifting unit. Particularly preferably, a seal is arranged in the region of the entry opening or in the region of the exit opening, and this seal seals the entry opening and exit opening to the outside when they come to lie opposite one another. Particularly preferably, the neutralization unit having a pipe section, on whose end the exit opening is situated, engages into the entry opening of the lifting unit. Thereby, a seal, on which the pipe section comes to bear in a sealing manner, may be arranged in the entry opening.

Particularly preferably, the neutralization unit comprises several exit openings and the lifting unit at its upper side comprises a number of entry openings which corresponds to the number of exit openings, wherein the entry openings are arranged in a manner such that in each case an exit opening lies opposite one of the entry openings, when the neutralization unit is arranged on the upper side of the lifting unit. Thereby, the connection may be effected in each case between the exit opening and entry opening with all connections, in the previously described manner. Particularly preferably, four exit openings are provided on the neutralization unit and four entry openings on the lifting unit. If the neutralization unit and lifting unit have an essentially rectangular cross section, it is preferable for the exit openings and entry openings to be arranged in the vicinity of the four corners of the cross section. The neutralization unit for this, particularly preferably, on its lower side comprises four pipe sections arranged at the corners, and these pipe sections in each case enter one of the four entry openings which are arranged on the upper side of the lifting unit at its four corners. Thereby, a sealing may be effected by a seal, as was previously described.

According to a further preferred embodiment, the neutralization unit comprises at least one recess which is designed for receiving an exit conduit extending away from the lifting unit. Such an exit conduit extends away from the lifting unit, preferably upwards. Despite this, in order then to be able to arrange the neutralization unit on the upper side of the lifting unit, the neutralization unit preferably comprises the described recess, by which the exit conduit of the lifting unit may extend further upwards. Such a recess extends preferably over the complete vertical extension of the neutralization unit, so that the exit conduit may exit at the upper side of the neutralization unit.

According to a special embodiment, the neutralization unit on its lower side comprises feet for setting-up the neutralization unit. These feet are further preferably designed in a removable manner. The stand feet permit the optional placing or setting-up of the neutralization unit independently of the lifting unit. Thus, the neutralization unit may be set up, for example, on the stand feet next to the lifting unit, instead of being placed onto the upper side of this. The removable stand feet have the advantage that these feet may be removed in a case in which the neutralization unit is to be placed onto the upper side of the lifting unit as previously described. This means that the feet are only assembled if the neutralization unit is to be set up on a surface independently of the lifting unit.

Further preferably, at least one of the stand feet is designed as a closure element which may be inserted into an exit opening on the lower side of the neutralization unit is a sealing manner. Preferably, all the stand feet are designed as such closure elements. Thereby, preferably as many feet are provided as there are as exit openings, so that all exit openings may be closed respectively by a stand foot. If, as described above, four exit openings are provided, which are formed for example at the four corners of the lower sides of the neutralization unit, accordingly one may provide four stand feet which are designed as closure elements, in order to close these four exit openings and simultaneously to attach the stand feet for setting up the neutralization unit on this. If the neutralization unit is not set up or placed on the lifting unit, but is set up independently of this, the exit openings on the lower side are preferably not used and are closed, since in this case the condensate may then be led from the neutralization unit to the lifting unit in another manner, as is described in more detail further below. The number of necessary individual parts is reduced, and moreover, the assembly is simplified by the double function of the stand feet which simultaneously seal off exit openings which are not required.

The neutralization unit preferably comprises at least one exit opening for the case where the neutralization unit is set up independently of the lifting unit, in particular next to this. This means that this lateral exit opening may be used, in order to lead the condensate away and out of the neutralization unit to the lifting unit, when the neutralization unit is set up next to the lifting unit. The lower exit openings are then preferably closed, as previously described. Usefully, several lateral exit openings are arranged on the neutralization unit. Preferably, in each case lateral exit openings are provided on at least two side surfaces of the neutralization unit which are away from one another and, in particular, on two opposite side surface. Thus, the exit of condensate may be effected to different sides, depending on which side of the neutralization unit the lifting unit is arranged.

According to a particular embodiment of the invention, the neutralization unit may comprise fasteners which are designed for fastening the neutralization unit on a wall. This optionally permits the neutralization unit to be fastened even next to the lifting unit on a wall. If the neutralization unit is placed onto the lifting unit, the neutralization unit may ideally be fastened together with the lifting unit, if attachment on a wall is to be desired.

The described lateral exit opening of the neutralization unit preferably has a vertical distance to a lower set-up (placement) surface of the neutralization unit, which for example is formed by feet, and this distance is larger than the vertical distance at least of one entry opening of the lifting unit to the lower set-up surface of this. In this manner, one ensures that the run-off of the condensate out of the lateral exit opening of the neutralization unit into the entry opening of the lifting unit is possible when the lifting unit and the neutralization unit are set up next to one another on a planar set-up surface. This is only possible with a higher arrangement of the lateral exit opening than the entry opening of the lifting unit. The neutralization unit for this may have suitably high feet or set-up elements, which ensure the described distance to the set-up surface.

Further preferably, the receiver space for a neutralizing agent in the neutralization unit has a vertical distance to a lower set-up surface of the neutralization unit, wherein this surface is preferably formed by the described feet, which is greater than the vertical distance of at least one entry opening of the lifting unit to its lower set-up surface. In particular, the lower side or the base of the receiver space lies vertically above the entry opening of the lifting unit when the neutralization unit and the lifting unit are set up next to one another on a planar surface. The run-off of the condensate out of the receiver space into the lifting unit is ensured in this manner. This run-off of the condensate is then particularly preferably effected through the previously described lateral exit opening of the neutralization unit and then via a flexible tube or a pipe conduit into an entry opening of the lifting unit.

Particularly preferably, the neutralization unit, at least on its lower side, has a peripheral contour which corresponds to the peripheral contour of the lifting unit, at least at its upper side. The design of the lifting unit and the neutralization unit having equal or matching peripheral contours has the advantage that a harmonic transition is created between both when the neutralization unit is placed onto the lifting unit. In particular, the lifting unit and the neutralization unit then have flush outer surfaces or outer sides which connect together or merge into one another in a harmonic manner.

The neutralization unit for the previously described condensate lifting installation system may furthermore have a r preferred feature which may also be realized independently of the other previously described features. Thus, the neutralization unit may comprise a receiver space for a neutralizing agent, for example a granulate of dolomite or magnesium oxide and/or the like. According to this particular embodiment, a testing device for detecting the pH-value of the neutralizing agent is arranged on or in the receiver space. The testing device is designed, for example, as an indicator which on reaching a predefined pH value signals this or displays this. In the simplest case, the testing device may be a test strip which changes its color when there is a change of the pH-value. Then via the testing device, one may easily ascertain whether the granulate or neutralizing agent is used up and must be replaced. If the testing device signals the reaching of a defined pH-value, for example by color change, the user knows that he must exchange the neutralizing agent. Particularly preferably, the neutralizing agent together with the testing device may be accommodated in an exchangeable pump, which may then be completely exchanged.

This means that the used cartridge is removed from the receiver space and a new cartridge is inserted instead of this. Thus, a very simple maintenance of the neutralization unit is possible.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a side view of a condensate lifting installation system according to an embodiment of the invention, in which a neutralization unit is set up placed onto a lifting unit;

FIG. 2 is a side view of a condensate lifting installation system, according to an embodiment where the neutralization unit is set up next to a lifting unit;

FIG. 3 is a sectional view of the arrangement according to FIG. 2;

FIG. 4 is an enlarged view of the detail IV of FIG. 3;

FIG. 5 is a perspective view of a neutralization unit according to an embodiment of the invention; and

FIG. 6 is a perspective view of a lifting unit according to an embodiment of the invention.

### DETAILED DESCRIPTION OF THE INVENTION

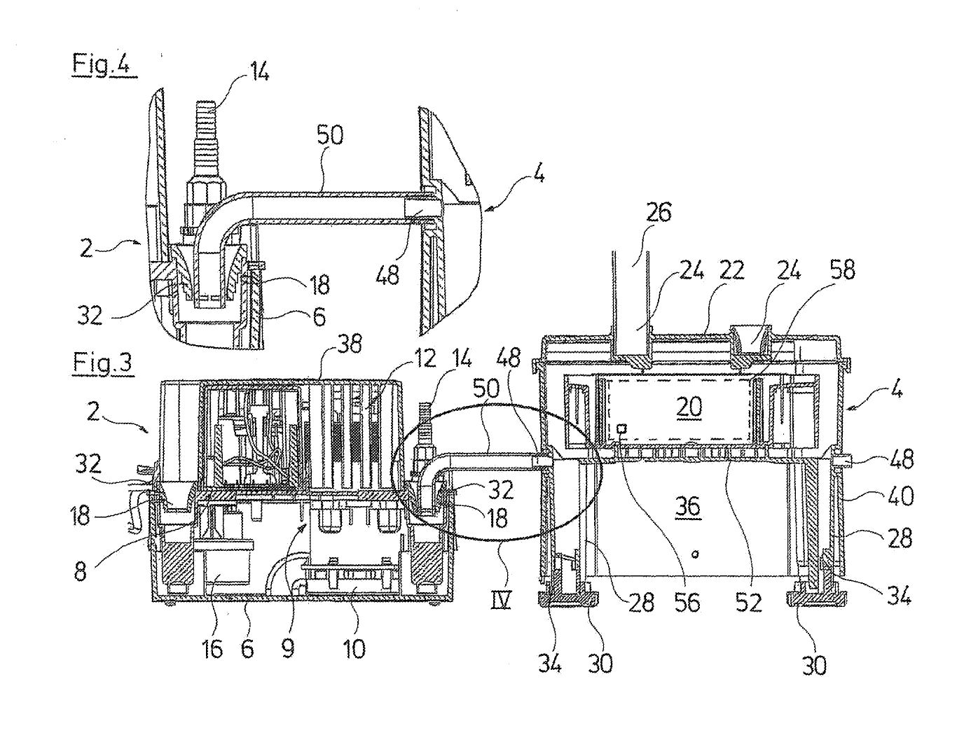

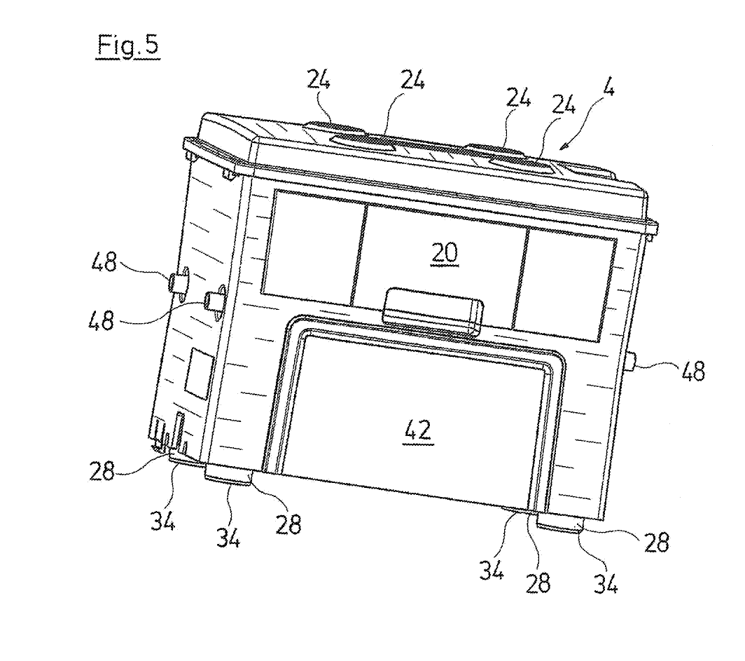

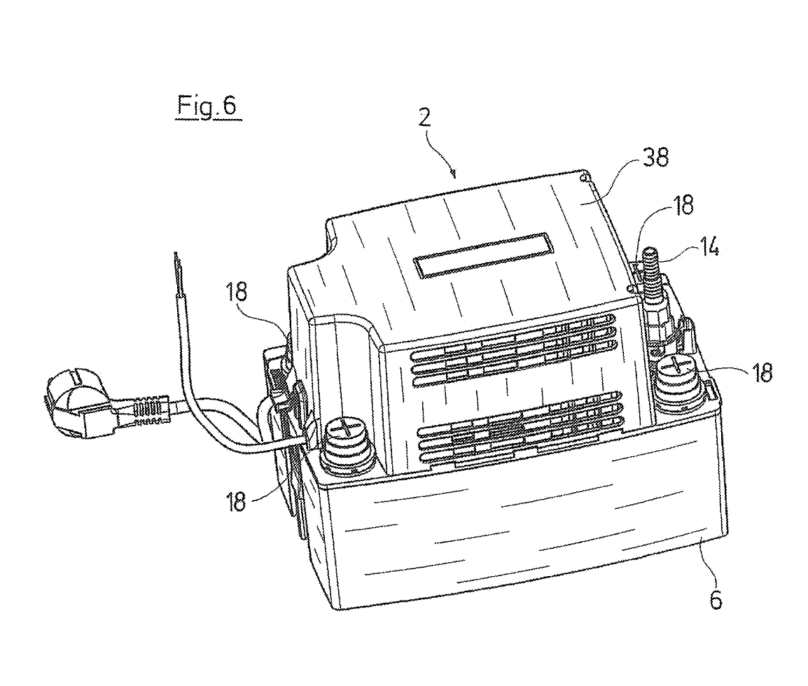

The shown condensate lifting installation system comprises basically two constituents or units, specifically on the one hand a lifting unit 2 and on the other hand a neutralization unit 4. As may be recognized in the sectional view of FIG. 3, the lifting unit 2 comprises a collection container 6, which is designed in an open manner on its upper side. The open upper side of the collection container 6 is closed by a cover 8. The cover 8 carries a pump assembly 9, wherein the pump 10 of the pump assembly is arranged below the cover 8 in the inside of the collection container 6, and an electrical drive motor 12 of the pump assembly is arranged above the cover 8 and drives the pump 10 via a shaft, which is not shown here. The pump 10 is envisaged to pump condensate or waste water out of the inside of the collection container 6 into an exit conduit 14. A float switch 16 is arranged in the connection container 6 for switching the pump assembly 9 on and off in dependence on the water level in the inside of the collection container 16.

Four entry openings 18 are provided in the cover 8 at the four corners, through which condensate or waste water may enter into the inside of the collection container 6.

The second unit of the condensate lifting installation system is the neutralization unit 4. This in its inside comprises a receiver space 20 in which a neutralizing agent, for example a granulate which contains dolomite or the like, may be arranged. The neutralization unit 4 is closed by a cover above the receiver space 20 in which cover entry openings 24 are arranged. The entry openings 24 serve for the connection of at least one entry conduit which feeds condensate, for example from a heating installation. Preferably, the four entry openings 24 are arranged in the cover, wherein only two entry openings may be recognized in the views shown here. The several entry openings 24 serve for being able to connect entry conduits 26 from different directions.

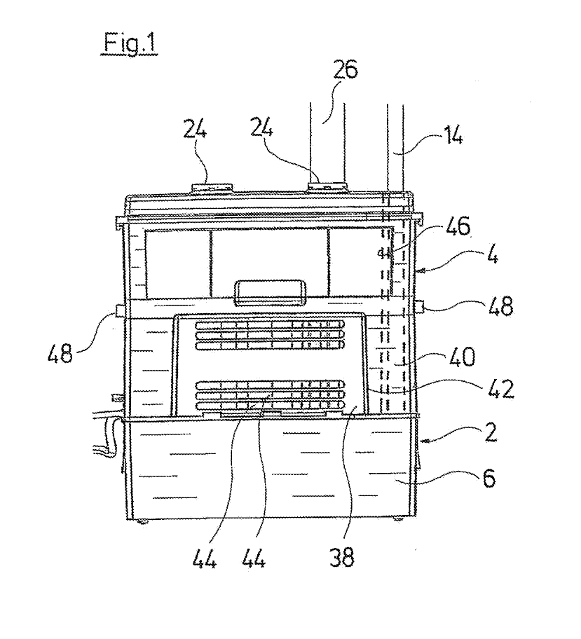

The neutralization unit 4 below the receiver space 20 comprises four tubular feet 28, which are arranged on the four corners of the receiver space 20, and which have an essentially rectangular cross section. The tubular feet 28 at their upper side are connected to the receiver space 20 and are designed in an open manner at their lower end. The neutralization unit 4 is designed such that it may be placed onto the upper side of the lifting unit 2 as shown in FIG. 1. For this, the stand feet 30 may be removed from the open, lower ends of the feet 28. Then the tubular feet 28 may be inserted from above into the entry openings 18 of the lifting unit 2, wherein they are sealed to the outside by the seals 32. With this arrangement, the lower ends of the tubular feet 28 thus form exit openings 34, which lie opposite the entry openings 18 or engage into these. Thus, neutralized condensate, which exits out of the receiver space 20, may run through the tubular feet directly into the entry openings 18 of the lifting unit 2.

The free space 36 between the tubular feet 28 is designed such that the upper housing part 38 of the lifting unit 2, which in particular covers the electric motor 12, may engage into this free space 36 and be accommodated there, so that the neutralization unit 4 may be placed onto the lifting unit 2 in the manner shown in FIG. 1. The neutralization unit 4 in its lower region, which is formed by the tubular feet 28, is encased by an outer wall 40, which at its lower end has a cross-sectional shape, which corresponds essentially to the cross sectional shape of the upper end of the collection container 6, so that when the neutralization unit 4 is placed onto the lifting unit 2, a smooth or harmonic transition between them is achieved, as seen in FIG. 1. The outer wall 40 on its side comprises a recess 42, into which the outer wall of the upper housing part 38 of the lifting unit 2 engages in a direct manner, so that its cooling openings 44 remain open to the outside even when the neutralization unit 4 is placed on it.

The neutralization unit 4, moreover, at one side comprises a recess 46, through which the exit conduit 14 may extend vertically upwards.

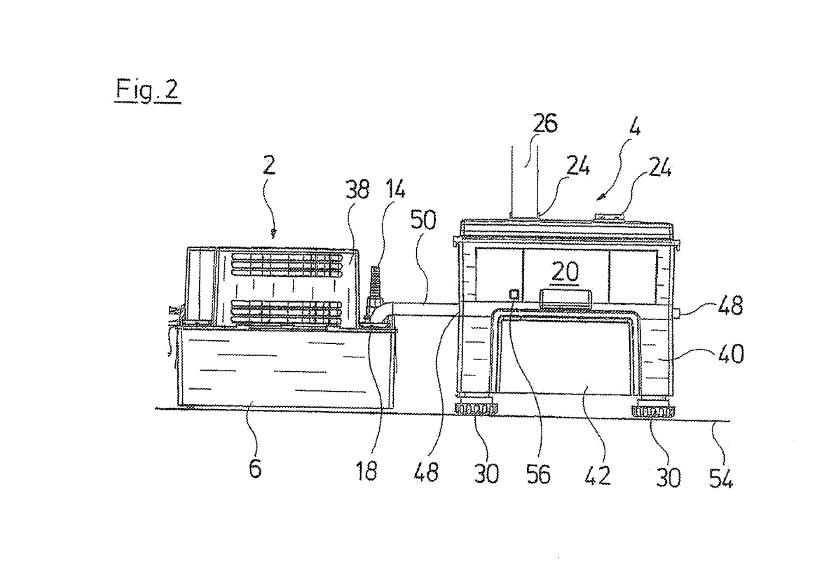

Instead of placing the neutralization unit 4 onto the lifting unit 2, as shown in FIG. 1, the neutralization unit 4 may also be set up next to the lifting unit 2, as shown in FIGS. 2 and 3. With this arrangement, the exit openings 34 are closed by the stand feet 30 at the lower ends of the tubular feet 28. The stand feet 30 are preferably designed of an elastomer or rubber and thus simultaneously form closure plugs. With this arrangement, a lateral exit opening 48 is used, which is arranged roughly on the base of the receiver space 20, which is to say is situated at the upper end of the tubular feet 28. A flexible tube or pipe 50 is connected to this lateral exit opening 48 and engages into an entry opening 18 of the lifting unit 2 and the seal 32 which is arranged therein. The tubular feet 28 have such a vertical height, that the base 52 of the receiver space is situated vertically above the entry opening 18, when the lifting unit 2 as well as the receiver unit 4 are set up together next to one another on a plane surface 54. Thus, the condensate may flow from the receiver space 40 via the pipe 50 into the collection container 6.

The stand feet 30 are preferably height-adjustable in the exit openings 34, for example via a thread or a spiral-like contact surface. Thus, the stand feet 30 permit an alignment of the neutralization unit 4 on an uneven or oblique surface.

As may be recognized in FIGS. 1, 2 and 3, the neutralization unit 4 also comprises several lateral exit openings 48. Of these, only one is used in the shown example. The others are closed in a suitable manner. This may be effected by the openings 48 basically first being closed by a wall, and only the opening 48 which is required is opened by the wall being broken out. Alternatively, a closure by closure plugs is possible. This arrangement of several lateral exit openings 48 creates the possibility of arranging the neutralization unit 4 even on the other side of the lifting unit 4, which means not to the right, but to the left in the examples shown here. Then, another entry opening 18 of the lifting unit would also be used in a corresponding manner, in order to connect the neutralization unit 4 to the lifting unit 2 via a pipe 50.

In the arrangement shown in FIGS. 2 and 3, the lifting unit 2 and the neutralization unit 4 could also be fastened on a wall instead of placing it onto a set-up surface 54. For this, the lifting unit 2 and the neutralization unit 4 may comprise fasteners on a side wall, which are not shown in more detail here.

One may recognize that the modular construction of the condensate lifting installation system, comprising the lifting unit 2 and of the neutralization unit 4, permits a very flexible installation, since either the neutralization unit 4 may be arranged on the lifting unit 2 or, as shown in FIGS. 2 and 4, both may alternatively also be arranged next to one another, depending on the existing space. Moreover, the same lifting unit 2 may also be applied as a whole without the neutralization unit 4, if a neutralization of the condensate is not necessary. In this case, the entry conduit 26 may be led directly into one of the entry openings 18 on the collection container 6.

An indicator 56 in the form of a litmus paper, which colors when the pH-value in the inside of the collection container 20 changes, may be arranged in the receiver space 20, in order to recognize when the neutralization unit in the receiver space 20 is used up. Thus, one may recognize from the outside whether the neutralizing agent is used up and needs to be exchanged. The neutralizing agent and the indicator 56 may be arranged together in an exchangeable cartridge 58 inserted into the receiver space 20, for the simple exchange.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/We claim:

1. A condensate lifting installation system comprising: a lifting unit (2) having a collection container (6) and a pump assembly (9) and a neutralization unit (4) having a receiver space (20) for a neutralizing agent, wherein the lifting unit (2) is designed at its upper side for releasable attachment of the neutralization unit (4).

2. The condensate lifting installation system according to claim 1, wherein the lifting unit (2), at its upper side, has a shape corresponding to a shape of a lower side of the neutralization unit (4), such that the upper side of the lifting unit (2) and the lower side of the neutralization unit (4) may come into releasable engagement with one another.

3. The condensate lifting installation system according to claim 2, wherein the shape of the upper side of the lifting unit is defined by an outer housing part (38) of the lifting unit (2).

4. The condensate lifting installation system according to claim 1, wherein the neutralization unit (4) at its lower side comprises at least one exit opening (34) and the lifting unit (2) on its upper side comprises at least one entry opening (18), the openings (18, 34) being arranged in a manner such that the at least one exit opening (34) lies opposite the at least one entry opening (18) when the neutralization unit (4) is arranged on the upper side of the lifting unit (2).

5. The condensate lifting installation system according to claim 4, wherein the neutralization unit (4) comprises a number of exit openings (34), and the lifting unit (2) on its upper side comprises a number of entry openings (18) corresponding to the number of exit openings (34), and wherein the entry openings are arranged in a manner such that each of the exit openings (34) lies opposite a respective one of the entry openings (18) when the neutralization unit (4) is arranged on the upper side of the lifting unit (2).

6. The condensate lifting installation system according to claim 1, wherein the neutralization unit (4) comprises at least one recess (46) designed for receiving an exit conduit (14) extending away from the lifting unit (2).

7. The condensate lifting installation system according to claim 1, wherein the neutralization unit (4) on its lower side comprises stand feet (30) for set-up of the neutralization unit (4).

8. The condensate lifting installation system according to claim 7, wherein at least one of the stand feet (30) is designed as a closure element insertable in a sealing manner into an exit opening (34) on the lower side of the neutralization unit (4).

9. The condensate lifting installation system according to claim 1, wherein the neutralization unit (4) comprises fasteners designed for fastening the neutralization unit (4) on a wall.

10. The condensate lifting installation system according to claim 1, wherein the neutralization unit (4) comprises at least one lateral exit opening (48).

11. The condensate lifting installation system according to claim 10, wherein the lateral exit opening (48) has a vertical distance to a lower set-up surface of the neutralization unit (4), the distance being formed preferably by stand feet (30), and the distance being larger than a vertical distance of at least one entry opening (18) of the lifting unit (2) to its lower set-up surface.

12. The condensate lifting installation system according to claim 1, wherein the receiver space (20) for a neutralizing agent has a vertical distance to a lower set-up surface of the neutralization unit (4), the distance being formed by stand feet (30), and the distance being larger than a vertical distance of at least of one entry opening (18) of the lifting unit (2) to its lower set-up surface.

13. The condensate lifting installation system according to claim 1, wherein the neutralization unit (4) at least on its lower side has a peripheral contour corresponding at least to a peripheral contour of the lifting unit (2) on its upper side.

14. The condensate lifting installation system according to claim 1, further comprising a testing device (56) for detecting a pH-value of a neutralizing agent located on or in the receiver space (20).
